(19) United States
(12) Patent Application Publication
(10) Pub. No.: US 2024/0182144 A1
(43) Pub. Date: Jun. 6, 2024

(54) SHIP DOCKING SYSTEM AND SHIP DOCKING METHOD

(71) Applicant: Metal Industries Research & Development Centre, Kaohsiung (TW)

(72) Inventors: Kuang-Shine Yang, Tainan City (TW); Ping-Hua Su, Kaohsiung City (TW); Chao Chieh Hsu, Kaohsiung City (TW)

(73) Assignee: Metal Industries Research & Development Centre, Kaohsiung (TW)

(21) Appl. No.: 18/074,520

(22) Filed: Dec. 5, 2022

(51) Int. Cl. B63B 79/40; B60L 53/30; B60L 53/50; B64C 39/02; B64U 50/37; B64U 80/25; G06T 7/246; G08G 5/04; H04N 7/18; H04N 23/698

(52) U.S. Cl. CPC B63B 79/40; B60L 53/30; B60L 53/50; B64C 39/024; B64U 50/37; B64U 80/25; G06T 7/248; G08G 5/04; H04N 7/183; H04N 23/698; B64U 2101/30; G06T 2207/10032

(57) ABSTRACT

A ship docking system and a ship docking method are provided. The ship docking system includes a computing device, an unmanned aerial vehicle communicating wirelessly with the computing device and pre-docked on a charging platform, and a display device communicating wirelessly with the computing device. When the computing device determines that the ship is performing a port entry operation, the computing device controls the unmanned aerial vehicle to move to a preset height above the ship and to obtain a panoramic image of the ship. The unmanned aerial vehicle transmits the panoramic image to the computing device, so that the computing device analyzes the panoramic image to perform a collision prediction of the ship, and transmits a collision prediction result to the display device.

### BACKGROUND

### Technical Field

The disclosure relates to a docking judgment technology, and in particular, to a ship docking system and a ship docking method.

### Description of Related Art

At present, the docking of ships is currently based on the experience and judgment of the pilot or the captain to determine the movement path of the ship. However, since other ships may suddenly intrude into the moving path of the ship during the docking process of the ship, or the position of the environmental obstacle and the distance between the hull and the obstacle may be misjudged, accidents such as collision or grounding often occur during the current docking process of the ship.

### SUMMARY

The disclosure provides a ship docking system and a ship docking method, which can automatically generate ship docking information for reference by ship drivers.

The ship docking system of the disclosure includes a computing device, an unmanned aerial vehicle, and a display device. The unmanned aerial vehicle communicates wirelessly with the computing device and is pre-docked on a charging platform. The display device communicates wirelessly with the computing device. When the computing device determines that the ship is performing a port entry operation, the computing device controls the unmanned aerial vehicle to move to a preset height above the ship, and the computing device controls the unmanned aerial vehicle to obtain a panoramic image of the ship. The unmanned aerial vehicle transmits the panoramic image to the computing device, so that the computing device analyzes the panoramic image to perform a collision prediction of the ship, and transmits a collision prediction result to the display device.

The ship docking method of the disclosure includes the following. An unmanned aerial vehicle is pre-docked on a charging platform. When a computing device determines that a ship is performing a port entry operation, the unmanned aerial vehicle is controlled to move to a preset height above the ship through the computing device. A panoramic image of the ship is obtained by controlling the unmanned aerial vehicle through the computing device. The panoramic image is transmitted to the computing device through the unmanned aerial vehicle. The panoramic image is then analyzed through the computing device to perform a collision prediction of the ship, and a collision prediction result is transmitted to a display device.

Based on the above, the ship docking system and ship docking method of the disclosure may use the unmanned aerial vehicle to obtain the panoramic image of the ship, and may generate the ship docking information for collision prediction by analyzing the panoramic image of the ship for reference by the ship driver.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

### BRIEF DESCRIPTION OF THE DRAWINGS

FIG. 1 is a schematic diagram of a ship docking system according to an embodiment of the disclosure.

FIG. 2 is a flow diagram of a ship docking method according to an embodiment of the disclosure.

FIG. 3 is a schematic diagram of a situation of a ship docking system according to an embodiment of the disclosure.

FIG. 4A to FIG. 4H are schematic diagrams of estimating a subsequent displacement position of a ship according to an embodiment of the disclosure.

FIG. 5 is a schematic diagram of determining whether a ship has collided according to an embodiment of the disclosure.

FIG. 6 is a schematic circuit diagram of a charging platform according to an embodiment of the disclosure.

FIG. 7 is a schematic diagram of a marking pattern according to an embodiment of the disclosure.

### DESCRIPTION OF THE EMBODIMENTS

In order to make the content of the disclosure more comprehensible, the following specific embodiments are described below as the examples to prove that the disclosure can actually be realized. In addition, wherever possible, elements/components/steps using the same reference numerals in the drawings and embodiments represent the same or similar parts.

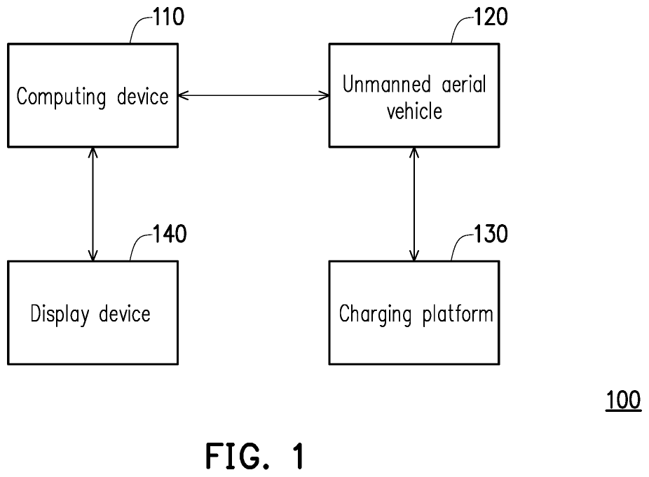

FIG. 1 is a schematic diagram of a ship docking system according to an embodiment of the disclosure. Referring to FIG. 1, a ship docking system 100 includes a computing device 110, an unmanned aerial vehicle 120, a charging platform 130, and a display device 140. The ship docking system 100 may be disposed on a ship or on a shore facility, but the disclosure is not limited thereto. In the embodiment, the computing device 110 is connected with the unmanned aerial vehicle 120 and the display device 140 through a wireless communication to transmit data. In the embodiment, the unmanned aerial vehicle 120 may be pre-docked on the charging platform 130 for charging. The unmanned aerial vehicle 120 may also include an image sensor (such as a wide-angle camera) and other components and devices required for flight and positioning.

In the embodiment, the computing device 110 may, for example, have a processor and a storage device (such as a memory). The processor is coupled to the storage device. The storage device may, for example, store an image processing module, a control module of the unmanned aerial vehicle 120, and various modules, software or algorithms required for realizing the disclosure, and the disclosure is not limited thereto. In the embodiment, the display device 140 may be a portable device.

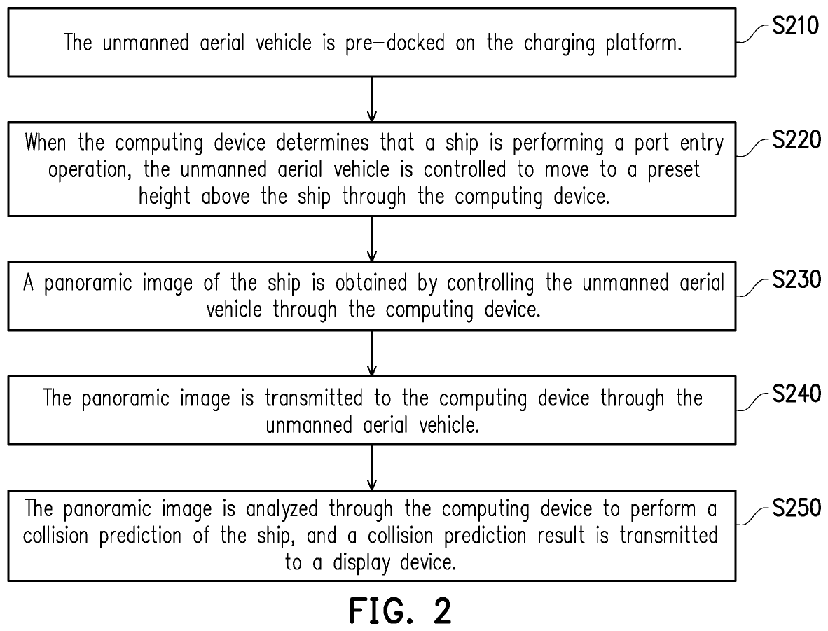

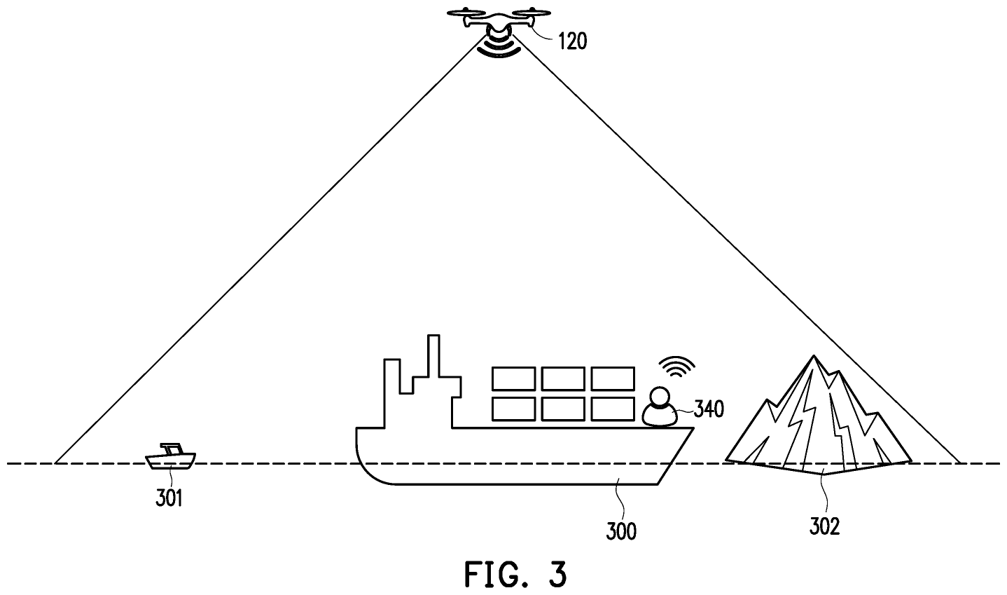

FIG. 2 is a flow diagram of a ship docking method according to an embodiment of the disclosure. FIG. 3 is a schematic diagram of a situation of a ship docking system according to an embodiment of the disclosure. Referring to FIG. 1 to FIG. 3, the ship docking system 100 may perform steps S210 to S250. In step S210, the computing device 110 may pre-dock the unmanned aerial vehicle 120 on the charging platform 130. The charging platform 130 may charge the unmanned aerial vehicle 120. In step S220, when the computing device 110 determines that a ship 300 is performing a port entry operation, the computing device 110 may control the unmanned aerial vehicle 120 to move to a position at a preset height above the ship 300. In the embodiment, as shown in FIG. 3, the unmanned aerial vehicle 120 may fly over the ship 300 and maintain the same position above the ship 300 as the ship 300 moves. In addition, the port entry operation may refer to a ship navigation operation in which the ship 300 proceeds to a port channel and intends to enter the port to dock. The disclosure may also be applied to the process of the ship 300 leaving the port.

In step S230, the computing device 110 may control the unmanned aerial vehicle 120 to obtain a panoramic image of the ship 300 through the image sensor. The panoramic image refers to an image that may include the ship 300, other ships 301, and obstacles 302. In an embodiment, the computing device 110 may also perform image processing on the panoramic image to generate an orthophoto, and perform collision prediction of the ship 300 according to the orthophoto. In the embodiment, as shown in FIG. 3, the unmanned aerial vehicle 120 may continuously capture the panoramic image of the ship 300, and the panoramic image includes the surrounding environment images of the ship 300. In step S240, the unmanned aerial vehicle 120 may transmit the panoramic image to the computing device 110. In step S250, the computing device 110 may analyze the panoramic image to predict the collision of the ship 300, and transmit the collision prediction result to the display device 140. In this way, the personnel 340 holding the display device 140, such as the crew, captain, or pilot, may receive the port entry position information, port entry environment information, and port entry collision prediction of the current ship 300 in real time, so as to effectively control the ship 300 and avoid accidents such as collision or grounding.

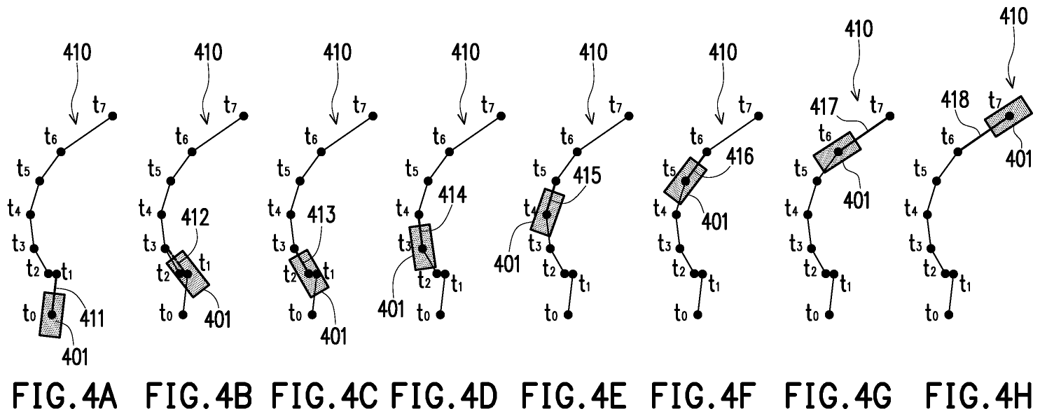

FIG. 4A to FIG. 4H are schematic diagrams of estimating a subsequent displacement position of a ship according to an embodiment of the disclosure. The collision prediction mentioned in the disclosure may refer to determining the path of the ship according to the channel of the ship through the computing device 110 and determining whether to generate the collision warning. For example, referring to FIG. 1 and FIG. 4A to FIG. 4H, the computing device 110 may perform image analysis based on the continuous panoramic image provided by the unmanned aerial vehicle 120 to determine the hull outline, hull features, and positioning information of a ship 401, etc., and the subsequent displacement position of the ship 401 may be estimated, for example, through an optical flow method, so as to generate the path information of the ship 401. Here, the path information may be used for the subsequent collision prediction.

In the embodiment, the computing device 110 may read the first panoramic image and the second panoramic image at adjacent time points of the ship 401, and calculate multiple feature points in the first panoramic image and the second panoramic image, respectively. The computing device 110 may calculate the optical flow formed by the feature points between the adjacent first panoramic image and the second panoramic image, so as to obtain multiple moving feature points. The computing device 110 may estimate the positions of the feature points of the first panoramic image in the second panoramic image, so as to filter out multiple feature points with unchanged positions. Therefore, the computing device 110 may estimate the subsequent displacement position of the ship 401 according to the moving feature points and the feature points with unchanged positions.

For example, in FIG. 4A, at time to, the ship 401 may move to the first position, and the unmanned aerial vehicle 120 may obtain the first panoramic image. The computing device 110 may estimate that the ship 401 may move to the second position via a displacement path 411 according to the first panoramic image and another panoramic image at a previous point in time. In FIG. 4B, at time t1, the ship 401 may move to the second position, and the unmanned aerial vehicle 120 may obtain the second panoramic image. The computing device 110 may estimate that the ship 401 may move to the third position via a displacement path 412 according to the first panoramic image and the second panoramic image. By analogy, in FIGS. 4C to 4H, at times t2 to t7, the unmanned aerial vehicle 120 may obtain the third to eighth panoramic images. The computing device 110 may respectively estimate that the ship 401 may move to the third position to the ninth position sequentially through displacement paths 413 to 418 according to the second panoramic image to the eighth panoramic image. Therefore, the computing device 110 may effectively generate a path 410 of the ship 401.

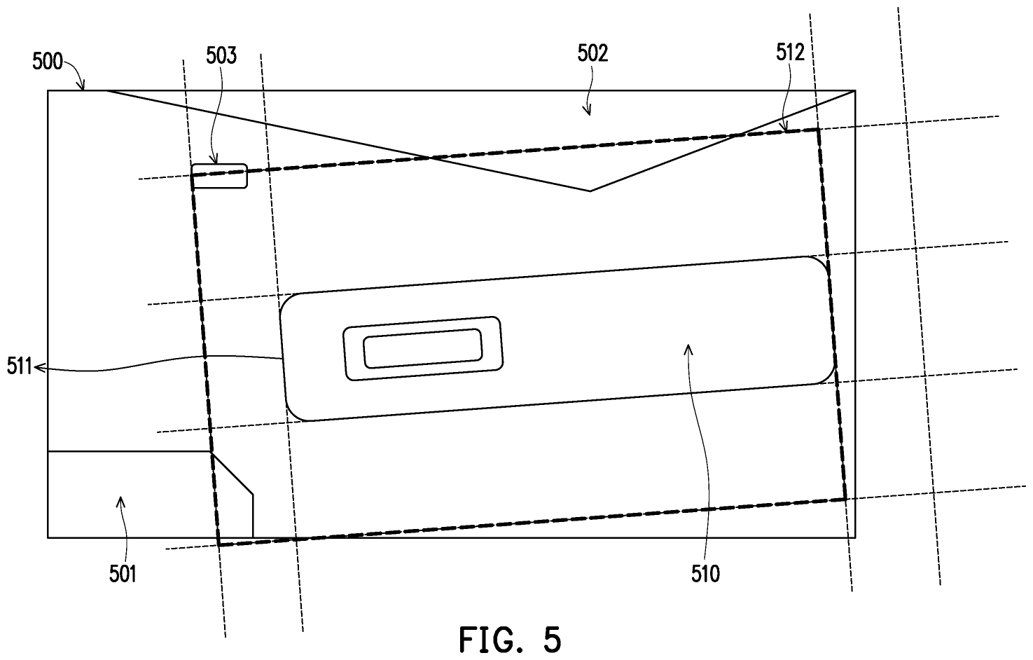

FIG. 5 is a schematic diagram of determining whether a ship has collided according to an embodiment of the disclosure. Referring to FIG. 1 and FIG. 5, for example, when the ship enters a relatively narrow channel for entering a port (that is, a ship 510 enters a port to dock), the unmanned aerial vehicle 120 may take off from the charging platform 130 and fly right above the ship to capture a panoramic image 500 of the ship, and transmits back to the computing device 110 for image analysis, so as to analyze a ship image 510 in the panoramic image 500 to obtain the hull outline, hull features, and positioning information of the ship. As shown in FIG. 5, the computing device 110 may perform the estimation as in the above-mentioned embodiment to obtain a path 511 of the ship.

In the embodiment, the computing device 110 may determine whether the probability value of the ship colliding with an obstacle on the path 511 is higher than a preset threshold value, so as to generate the collision warning. As shown in FIG. 5, the computing device 110 may determine the distance between the ship image 510 and surrounding obstacle images 501 to 503 (including other ships or foreign objects) to calculate the probability value of collision. In an embodiment, the computing device 110 may also determine whether a moving object approaches and enters the safe range of the ship, so as to generate the collision warning. As shown in FIG. 5, the computing device 110 may determine that an obstacle image 502 (other moving ships) approaches and enters a preset range 512 of the ship image 510, and generates the collision warning. In the embodiment, the collision warning may refer to warning information such as warning images, warning notifications, warning icons and/or warning sounds sent by the computing device 110 to the display device 140, but the disclosure is not limited thereto.

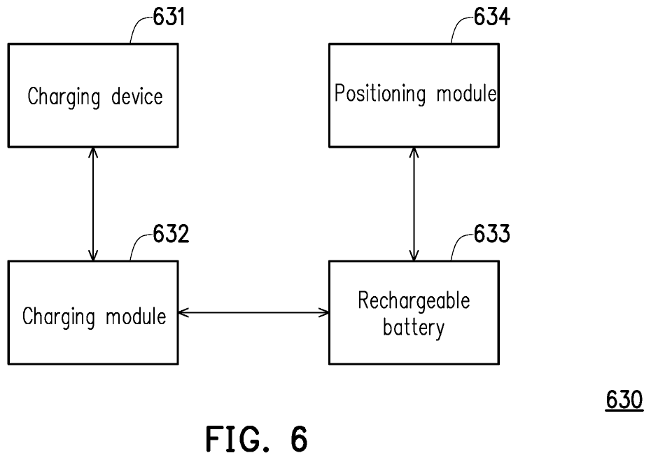

FIG. 6 is a schematic circuit diagram of a charging platform according to an embodiment of the disclosure. Referring to FIG. 6, the charging platform mentioned in various embodiments of the disclosure may be implemented as a charging platform 630 as shown in FIG. 6. In the embodiment, the charging platform 630 includes a charging device 631, a charging module 632, a rechargeable battery 633, and a positioning module 634. In the embodiment, when the unmanned aerial vehicle is docked on the charging platform 630, the charging device 631 may be used to automatically contact the charging device of the unmanned aerial vehicle. The charging device 631 may be, for example, a fixed charging rod, and when the unmanned aerial vehicle is docked on the charging platform 630, the charging device of the unmanned aerial vehicle may contact the fixed charging rod to perform an automatic charging operation. The charging module 632 is electrically connected to the charging device 631. The rechargeable battery 633 is electrically connected to the charging module 632. The charging module 632 may convert the power provided by the rechargeable battery 633 through voltage and/or current conversion to generate the charging power (or charging signal) required by the unmanned aerial vehicle. When the unmanned aerial vehicle is docked on the charging platform 630, the charging platform 630 may obtain the charging power from the charging module 632 and the rechargeable battery 633 through the charging device 631 to charge the unmanned aerial vehicle. The positioning module 634 is disposed on the charging platform 630. When the computing device controls the unmanned aerial vehicle to return to the charging platform 630, the unmanned aerial vehicle may locate the position of the charging platform 630 through the positioning module 634.

In the embodiment, the unmanned aerial vehicle may, for example, photograph the positioning module 634 through the image sensor, and may adjust the landing attitude, landing position and/or landing orientation by identifying the image of the positioning module 634, so as to accurately land on the charging platform 630 in a specific direction, attitude and/or orientation to effectively overcome the shortcomings of the traditional GPS which may not accurately land in a specific direction, attitude and/or orientation.

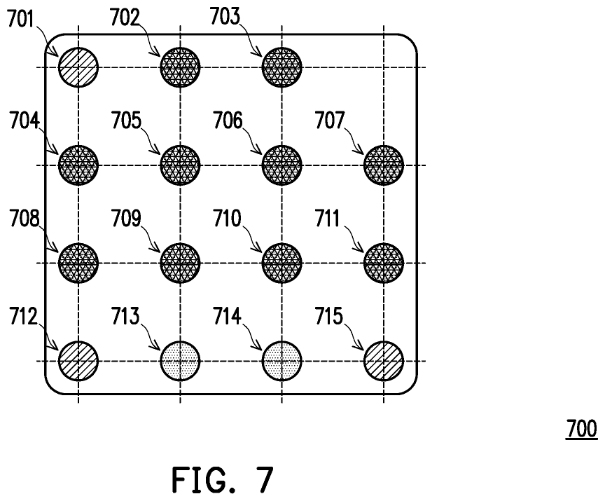

FIG. 7 is a schematic diagram of a marking pattern according to an embodiment of the disclosure. Referring to FIG. 7, the positioning module 634 of the above-mentioned embodiment may, for example, include a marking pattern 700. The marking pattern 700 includes multiple coded marking points 701 to 715. The marking points 701 to 715 are arranged in an array, and there may be the same fixed distance between the points. The marking points 701 to 715 may include multiple first marking points 702 to 711 for determining the number, multiple second marking points 713 to 714 for determining the orientation of the vehicle, and multiple third marking points 701, 712, and 715 for determining the attitude of the vehicle. The first marking points 702 to 711, the second marking points 713 to 714, and the third marking points 701, 712, and 715 may respectively have different colors or emit light of different colors. The first marking points 702 to 711 may, for example, have a first color. The second marking points 713 to 714 may, for example, have a second color. The third marking points 701, 712, and 715 may, for example, have a third color.

In the embodiment, the number is used to represent the vehicle number, so that the unmanned aerial vehicle may correctly determine whether the current charging platform is the correct landing target. Then, the unmanned aerial vehicle may determine the orientation of the vehicle according to the second marking points 713 to 714 (for example, the frontal orientation of the vehicle), so that the unmanned aerial vehicle may automatically turn to a specific orientation, for example, to facilitate the charging device of the unmanned aerial vehicle to automatically contact with the charging device of the charging platform 630 after landing. Finally, during the landing process of the unmanned aerial vehicle, the unmanned aerial vehicle may dynamically determine the distance change between the third marking points 701, 712, and 715 (if the attitude of the unmanned aerial vehicle changes, the unmanned aerial vehicle may see the distance between the third marking points 701, 712, and 715 changing as well), so as to determine whether the attitude of the unmanned aerial vehicle is correct, and the attitude of the unmanned aerial vehicle may be dynamically adjusted during the landing process. Therefore, the unmanned aerial vehicle may safely and correctly land on the charging platform according to the marking pattern 700.

To sum up, the ship docking system and ship docking method of the disclosure may use the unmanned aerial vehicle to first obtain the panoramic image of the ship, and may automatically analyze the panoramic image of the ship to generate the ship docking information for collision prediction, so as to provide to the personnel holding the display device (e.g., crew, captain, pilot, or relevant ship controllers) to assess the docking or port entry of the ship. The ship docking system and the ship docking method of the disclosure may automatically generate the collision warning to effectively avoid accidents such as collision or grounding during the docking or port entry process of the ship.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

What is claimed is:

1. A ship docking system, comprising:
a computing device;
an unmanned aerial vehicle, communicating wirelessly with the computing device, and pre-docked on a charging platform; and
a display device, communicating wirelessly with the computing device,
wherein the computing device controls the unmanned aerial vehicle to move to a preset height above the ship when the computing device determines that the ship is performing a port entry operation, and the computing device controls the unmanned aerial vehicle to obtain a panoramic image of the ship, and
the unmanned aerial vehicle transmits the panoramic image to the computing device, so that the computing device analyzes the panoramic image to perform a collision prediction of the ship, and transmits a collision prediction result to the display device.

2. The ship docking system according to claim 1, wherein the collision prediction comprises the computing device determining a path of the ship according to a channel of the ship, and determining whether to generate a collision warning.

3. The ship docking system according to claim 2, wherein the collision prediction further comprises the computing device determining whether a probability value of the ship colliding with at least one obstacle on the path is higher than a preset threshold value, so as to generate the collision warning.

4. The ship docking system according to claim 2, wherein the collision prediction further comprises the computing device determining whether a moving object approaches and enters a safe range of the ship, so as to generate the collision warning.

5. The ship docking system according to claim 2, wherein the computing device reads a first panoramic image and a second panoramic image at adjacent time points of the ship, and calculates a plurality of feature points in the first panoramic image and the second panoramic image,
the computing device calculates an optical flow formed by the feature points between the first panoramic image and the second panoramic image at the adjacent time points, so as to obtain a plurality of moving feature points, and the computing device estimates positions of the feature points of the first panoramic image in the second panoramic image, so as to filter out a plurality of feature points with unchanged positions, and
the computing device estimates a subsequent displacement position of the ship according to the moving feature points and the feature points with unchanged positions.

6. The ship docking system according to claim 2, wherein the collision warning comprises a warning sound or displays a position of a warning object on the display device.

7. The ship docking system according to claim 1, wherein the computing device performs an image processing on the panoramic image to generate an orthophoto, and performs the collision prediction of the ship according to the orthophoto.

8. The ship docking system according to claim 1, wherein the charging platform comprises:
a charging device, configured to contact the unmanned aerial vehicle;
a charging module, electrically connected to the charging device;
a rechargeable battery, electrically connected to the charging module; and
a positioning module, disposed on the charging platform,
wherein the unmanned aerial vehicle locates a position of the charging platform through the positioning module when the computing device controls the unmanned aerial vehicle to return to the charging platform, and the charging platform obtains a charging power from the charging module and the rechargeable battery through the charging device to charge the unmanned aerial vehicle when the unmanned aerial vehicle is docked on the charging platform.

9. The ship docking system according to claim 1, wherein a positioning module comprises a marking pattern, the marking pattern comprises a plurality of coded marking points, the marking points comprise a plurality of first marking points for determining a number, a plurality of second marking points for determining an orientation of a vehicle, and a plurality of third marking points for determining an attitude of a vehicle.

10. A ship docking method, comprising:
pre-docking an unmanned aerial vehicle on a charging platform; and
controlling the unmanned aerial vehicle to move to a preset height above a ship through a computing device when the computing device determines that the ship is performing a port entry operation;
controlling the unmanned aerial vehicle to obtain a panoramic image of the ship through the computing device;
transmitting the panoramic image to the computing device through the unmanned aerial vehicle; and
analyzing the panoramic image through the computing device to perform a collision prediction of the ship, and transmitting a collision prediction result to a display device.
